(19) United States
(12) Patent Application Publication
(10) Pub. No.: US 2010/0281019 A1
(43) Pub. Date: Nov. 4, 2010

(54) CREATING INFORMATION MAP APPARATUS AND CREATING INFORMATION MAP METHOD

(75) Inventor: Isamu WATANABE, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/767,307

(22) Filed: Apr. 26, 2010

(30) Foreign Application Priority Data
May 1, 2009 (JP) 2009-112045

(51) Int. Cl. G06F 17/30

(52) U.S. Cl. 707/722; 707/737; 707/E17.047; 707/E17.002

(57) ABSTRACT

An information map creating apparatus and method including summing strengths of associations of information elements and creating a duplicate of an information element selected on the basis of the sum of the strengths, calculating strengths, including direct paths, of the associations among the information elements in a state in which some association whose strength is relatively low is excluded from the associations of one of the information elements of a duplicate origin and the information element of a duplicate target, summing the strengths of the associations of each of the information elements, and excluding, from the object to be displayed, an association whose strength is relatively low among the associations of one information element among the information elements, whose strength summed by the summing unit is higher than the others.

### CROSS-REFERENCE TO RELATED APPLICATIONS

This application is based upon and claims the benefit of priority of the prior Japanese Patent Application No. 2009-112045, filed on May 1, 2009,the entire contents of which are incorporated herein by reference.

### FIELD

The embodiments described herein relate to an apparatus and a method of creating an information map.

### BACKGROUND

Generally, text mining products, patent analysis systems, etc., have an information-map creating and display function for assisting search and analysis. An information map illustrates a relationship among words or data items included in retrieved information or information to be analyzed (bibliographic information etc. of a patent or a document) as a network chart as shown in FIG. 1. The placement positions of words or data items (hereinafter referred to as “information elements”) on an information map and relation lines (edges) among the information elements are determined or created using co-occurrence information among the information elements (information indicating the degree of co-occurrence in one document) etc. For example, creating a word map as an information map allows the user to know the principal topic of a document group. Creating an IPC (International Patent Classification) map as an information map allows the user to know the dependency relation of the technical fields of a patent document group. Creating an inventor map as an information map allows the user to know the human network of a joint application. In this way, the information map allows the user to easily grasp the outline information of a mass document group.

To improve the legibility of drawings in information maps, it is important to simplify the drawings. To simplify the drawings, a technology for thinning out edges has been developed. For thinning out edges, a method for deleting the edges in increasing order of the strength of the association is common. However, such a simple thinning-out method has the possibility of concentrating edges on a specific node. This sometimes results in creating an information map having no sense (no information) as a network chart. For example, FIG. 2 is a diagram showing an example of an information map in which edges are concentrated on a specific node. The information map in FIG. 2 simply indicates that an information element X has relations with other information elements.

Thus, a technology for avoiding concentration of edges on a specific node by inventing a method for thinning out edges (for example, limiting the maximum number of edges of each node) is proposed (for example, Japanese Patent No. 4167855). The technology described in this document can avoid concentration of edges on a specific node, as shown in FIG. 3.

### SUMMARY

According to an embodiment of the invention, an information-map creating apparatus that creates an information map representing associations among information elements, the apparatus including duplicating unit for summing first strengths of the associations of individual information elements and creating a duplicate of an information element selected on the basis of a sum of the strengths, along with the associations of the selected information element.

Degree-of-association calculating unit for calculating second strengths, including direct paths, of the associations among the information elements in a state in which some association whose strength is relatively low is excluded from the associations of one of the information elements of a duplicate origin and the information element of a duplicate target.

Degree-of-association summing unit for summing the second strengths of the associations of each of the information elements of the duplicate origin and the duplicate target.

Duplication eliminating unit for excluding, from the object to be displayed, an association whose second strength is relatively low among the associations of one information element, whose strength summed by the summing unit is higher than the others, of the information elements of the duplicate origin and the duplicate target.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed. Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a diagram showing an example an information map;

FIG. 2 is a diagram showing an example of an information map in which edges are concentrated on a specific node;

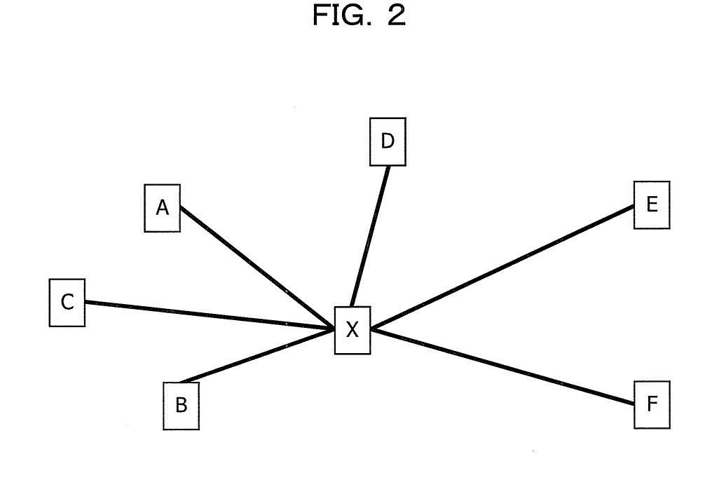

FIG. 3 is a diagram showing an example of an information map in which thinning-out is performed while concentration of edges on a specific node is avoided;

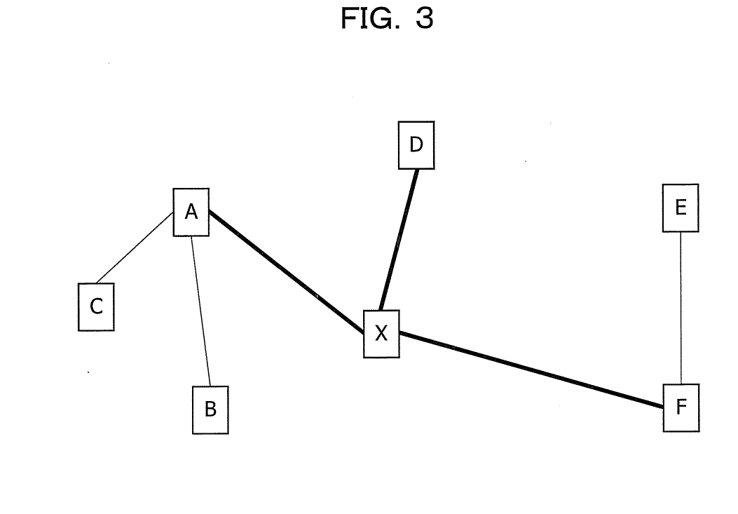

FIG. 4 is a diagram showing an example of an information map created by an embodiment;

FIG. 5 is a diagram showing a hardware configuration example of an information-map creating apparatus according to an embodiment of the present invention;

FIG. 6 is a diagram showing a functional configuration example of an information-map creating apparatus according to an embodiment;

FIG. 7 is a flowchart for describing a procedure of an information-map creating apparatus;

FIG. 8 is a diagram showing an example of statistical information of information elements;

FIG. 9 is a diagram showing an example of association information of information elements;

FIG. 10 is a flowchart for describing a procedure of an association thinning out process;

FIG. 11 is a first diagram showing a process of adding degrees of associations of indirect paths;

FIGS. 12A, 12B, 12C, 12D, 12E and 12F are diagrams for visually describing details of an association thinning out process;

FIG. 13 is a first diagram showing a process of calculating a degree of concentration of associations;

FIG. 14 is a diagram showing a process of duplicating an information element and associations;

FIG. 15 is a first diagram showing a process of thinning out an association duplicated due to duplication;

FIG. 16 is a second diagram showing a process of adding degrees of associations of indirect paths;

FIG. 17 is a diagram showing a result of thinning-out;

FIG. 18 is a diagram showing a process of calculating a degree of concentration of associations;

FIG. 19 is a diagram showing a process of thinning out an association duplicated due to duplication;

FIG. 20 is a diagram showing a process of adding degrees of associations of indirect paths; and

FIG. 21 is a diagram showing a result of thinning-out.

### DESCRIPTION OF EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

An embodiment will be specifically described with reference to the drawings.

First, an outline of a method for thinning out relation lines or the association lines (hereinafter referred to as “edges”) of an information map, disclosed in an embodiment, will be described. An embodiment is directed to avoiding concentration of edges on a specific node on which edges are concentrated in an information map by duplicating (or dividing) the node.

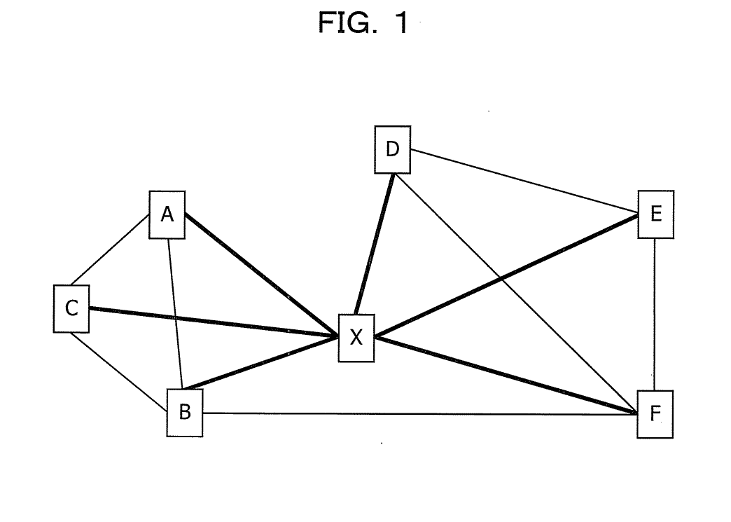

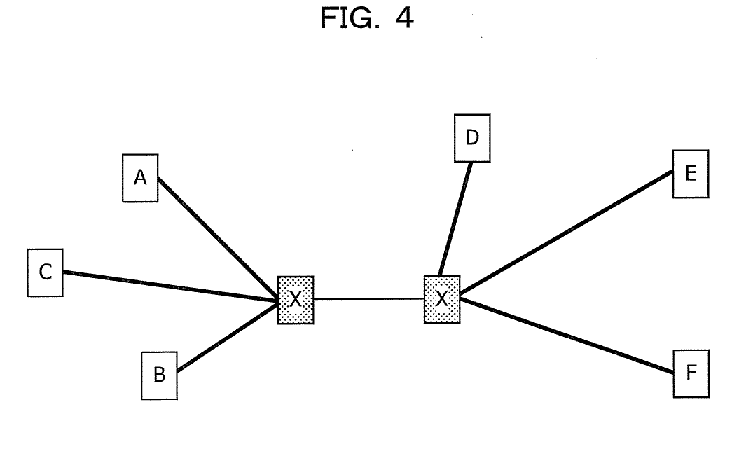

FIG. 4 is a diagram showing an example of an information map created according to an embodiment. FIG. 4 shows an example of a result of an application of the method for thinning out edges to the information map shown in FIG. 1.

In FIG. 4, a duplicate of a node X on which edges are concentrated is created (or the node X is divided), so that the edges concentrated on the node X are divided (distributed) to a duplicate origin and a duplicate target. As a result, the concentration of the edges on the specific node X can be avoided without eliminating the edges indicating strong associations concentrated on the node X.

However, when duplicating a node, a problem occurs in determining which of the duplicate origin and the duplicate target should be the distribution destination for the individual edges concentrated on the node. In the case of FIG. 1, it is desirable that nodes A, B, and C and nodes D, E, and F each having strong associations constitute individual groups, and that one group be connected to the duplicate origin and the other group be connected to the duplicate target. This is because the relationship among the other nodes other than the node X can also be stored (not be broken or direct). However, information about the duplicate origin and information about the duplicate target are the same, which makes it difficult to discriminate them in information processing of a computer. Thus, an embodiment solves this problem and other problems of edge distribution by using a degree of association (the strength of association) that reflects an indirect path. How the use of the degree of association that reflects an indirect path contributes to solving the problem is described in detail below. The indirect path is a path between two nodes, which is formed by edges other than an edge that directly connects the two nodes. For example, for nodes A and C in FIG. 1, a path, A-B-C, corresponds to the indirect path.

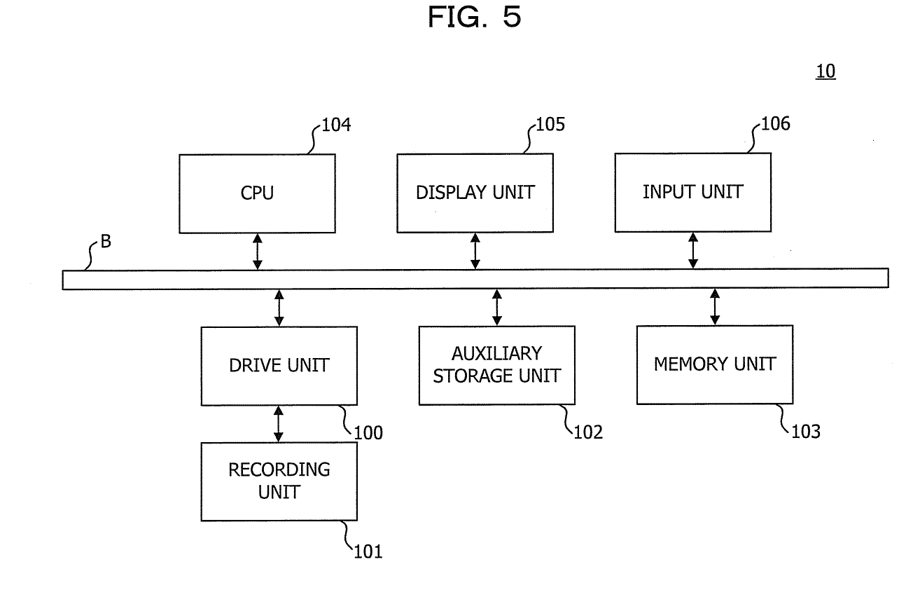

This will be described specifically hereinbelow. FIG. 5 is a diagram showing a hardware configuration example of an information-map creating apparatus according to an embodiment of the present invention. The information-map creating apparatus 10 in FIG. 5 includes a drive unit 100, an auxiliary storage unit 102, a memory unit 103, a CPU 104, a display unit 105, and an input unit 106, which are connected to each other with a bus B.

A program for achieving the processes of the information-map creating apparatus 10 is provided from a recording medium 101, such as a CD-ROM. When the recording medium 101 on which the program is recorded is set in the drive unit 100, the program is installed from the recording medium 101 through the drive unit 100 into the auxiliary storage unit 102. However, the program may not necessarily be installed using the recording medium 101 and may be downloaded from another computer via a network. The auxiliary storage unit 102 stores the installed program as well as necessary files, data, etc.

When an instruction to start the program, the memory unit 103 reads the program from the auxiliary storage unit 102 and stores it. The CPU 104 achieves the function of the information-map creating apparatus 10 in accordance with the program stored in the memory unit 103. The display unit 105 displays a GUI (graphical user interface) etc. according to the program. The input unit 106 is a keyboard, a mouse, or the like and is used to input various operational instructions.

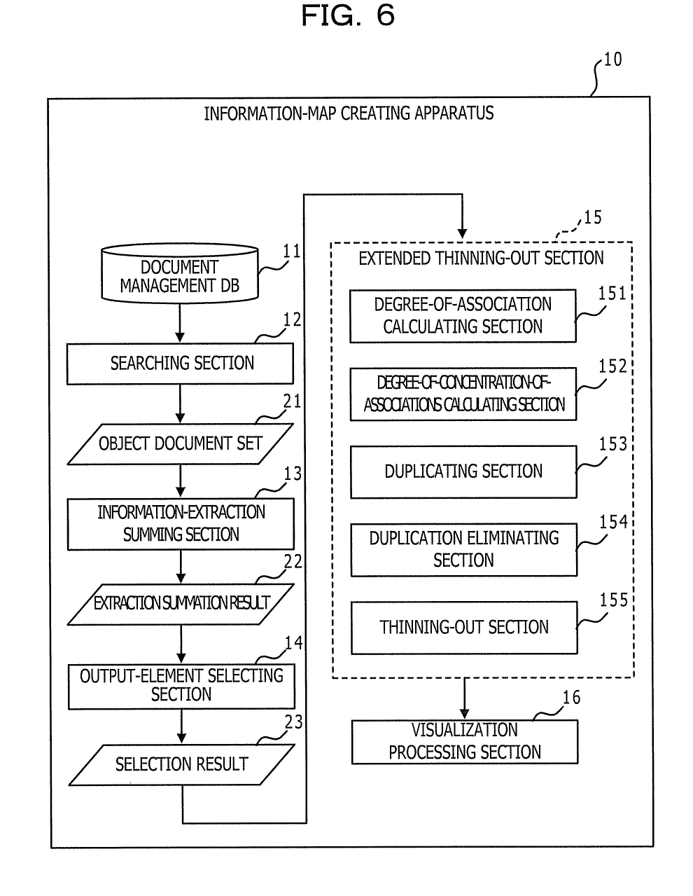

FIG. 6 is a diagram showing a functional configuration example of the information-map creating apparatus 10 according to an embodiment of the invention. In FIG. 6, the information-map creating apparatus 10 includes a document management DB 11, a searching unit 12, an information-extraction summing unit 13, an output-element selecting unit 14, an extended thinning-out unit 15, and a visualization processing unit 16. Any of the components of the apparatus 10 may be achieved by software including by processes that a program installed in the information-map creating apparatus 10 causes the CPU 104 to execute.

The document management DB 11 is a database that systematically manages documents (document data) using the auxiliary storage unit 102 (FIG. 5). In an embodiment, an object may be any kind of data or document including but not limited to patent documents, theses, books, business materials, and other various kinds of document.

The searching unit 12 searches the document management DB 11 for document data that meets input search criteria and outputs a set of retrieved documents as an object document set 21. In other words, the object document set 21 contains content(s) of the individual documents (bibliographic information, sentences, etc.). In an embodiment, the object document set 21 is an information set corresponding to the object of the information map. The object document set 21 may be provided from outside the information-map creating apparatus 10. Specifically, the object document set 21 may be input to the information-map creating apparatus 10 via a network, a portable recording medium, or the like. Accordingly, the information-map creating apparatus 10 may not necessarily have the document management DB 11 and the searching unit 12.

The information-extraction summing unit 13 executes an analysis including a common (known or well-known) information analysis process to extract information elements from the object document set 21, output statistical information on the information elements, and analyze the associations among the information elements, etc. The processing result of the information-extraction summing unit 13 is output as an extraction summation result 22. Accordingly, the extraction summation result 22 includes the extracted information elements, the statistical information, and the information of the associations (association information). The common information analysis process includes a morphological analysis process for dividing sentences into words, a modification analysis process for extracting subjects, predicates, objects, modification relations, etc., a statistical process for determining the frequency of appearance and the level of importance of words, etc., and a co-occurrence relation summation process for summing the number of times two words appear at the same time. The information elements are the components of an information set, which is the object of an information map, such as words extracted from the information set or the values of items in bibliographic information in a document, and can be nodes in the information map. In an embodiment, since the information elements are elements extracted from a document (i.e., the components of the document), they can also be referred to as document elements. The bibliographic information in the document includes, using a patent document as an example, items in an application or the title of the invention in a specification.

The output-element selecting unit 14 selects (chooses) information elements, to be displayed as nodes on an information map, from the information elements included in the extraction summation result 22. The selected information elements, statistical information and association information about the information elements, etc. are output as a selection result 23.

The extended thinning-out unit 15 executes a process for thinning out associations among the information elements. The associations are information represented as edges on an information map. Accordingly, the thinning-out of associations is substantially synonymous with thinning-out of edges (excluding from the object to be displayed). The former is an expression based on the viewpoint of computer processing, and the latter is an expression based on a visual viewpoint of an information map. Likewise, the information element and the node are substantially synonymous.

The extended thinning-out unit 15 includes a degree-of-association calculating section (unit) 151, a degree-of-concentration-of-associations calculating section (unit) 152, a duplicating section (unit) 153, a duplication eliminating section (unit)154, and a thinning-out section (unit) 155. The degree-of-association calculating unit 151 calculates the degrees of associations of individual information elements with the other information elements including indirect associations (indirect paths). The degree-of-concentration-of-associations calculating unit 152 calculates the degrees of concentration of associations of the individual information elements by calculating the total sum of the degrees of associations of the individual information elements. The duplicating unit 153 creates duplicates of information elements, including associations of thereof, selected on the basis of the degree of concentration of associations. The duplication eliminating unit 154 eliminates the duplication of the associations duplicated by the association duplicating unit 153. In other words, the duplication eliminating unit 154 thins out one of the associations of the duplicate origin and the associations of the duplicate target. The thinning-out unit 155 executes an association thinning out process including using a known method. Accordingly, the object to be thinned out by the thinning-out unit 155 is not limited to an association duplicated due to duplication.

The visualization processing unit 16 visualizes the information map on the basis of the result of the thinning out process of the extended thinning-out unit 15.

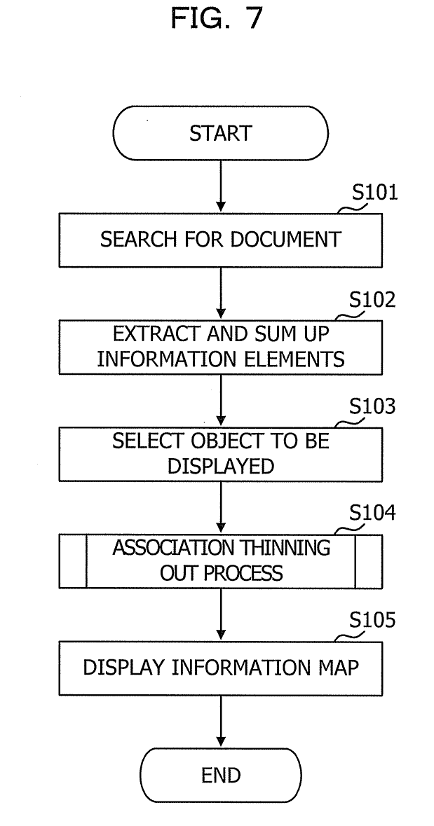

The procedure of the information-map creating apparatus 10 will be described below. FIG. 7 is a flowchart for describing a procedure of the information-map creating apparatus 10.

In response to, for example, an input of search criteria by the user, the searching unit 12, for example, searches the document management DB 11 for a set of documents that meets the search criteria and records the retrieved object document set 21 in the memory unit 103 or the auxiliary storage unit 102 (hereinafter referred to as “recording unit” (S101). The object document set 21 sometimes includes only one document depending on the search criteria. Next, the information-extraction summing unit 13, for example, analyzes the object document set 21 and outputs the extraction summation result 22 including the statistical information, the association information, etc. of the information elements to the recording unit (S102).

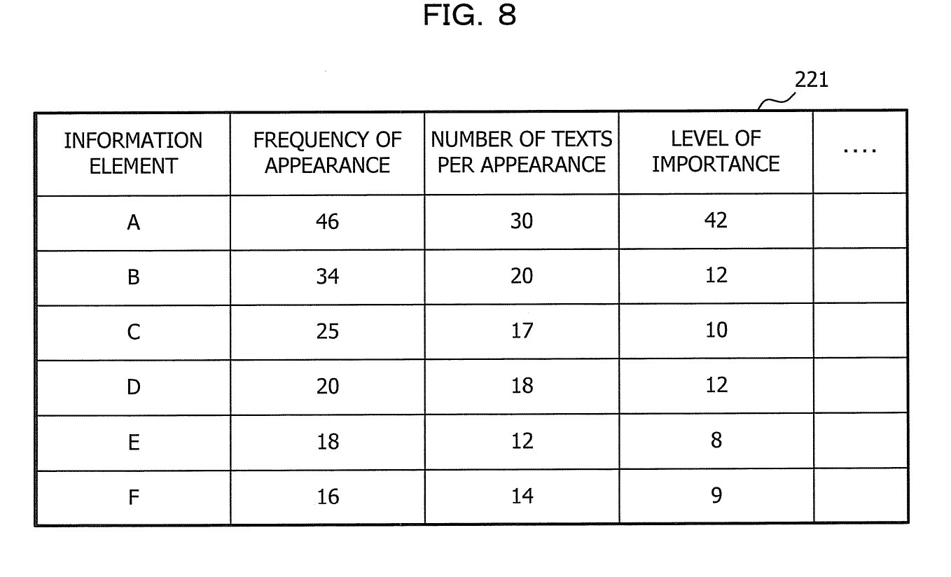

FIG. 8 is a diagram showing an example of statistical information of information elements. In FIG. 8, statistical information 221 includes the frequency of appearance, a number of texts per appearance, a level of importance, etc. for individual information elements extracted from the object document set 21. Alphabets (A to F) in FIG. 8 are abstract representation of the information elements, which applies to a description below. The frequency of appearance is the total sum of the frequency of appearance of the information elements of all the unit texts. The unit text is a set of semantic sentences, such as a paragraph or an article, as also described in “Text Mining Based on Keyword Association”, article by Watanabe, Isamu, and Kazuo Miki, Information Processing Society of Japan, the 55th Fundamental Informatics, 1999 (hereinafter also referred to as “Reference Document 1”). The number of appeared unit texts is the total sum of unit texts in which information elements appears. The level of importance is the level of importance of information elements in a set of unit texts and is found as the total sum of the levels of importance of information elements in a unit text. The level of importance of information elements in a unit text is determined as a function of statistical information of an information element in a narrow sense. The statistical information in a narrow sense is the probability of appearance of information elements in a unit text and the probability of appearance of information elements in a set of all unit texts, the frequency of appearance of information elements in a unit text, the number of unit texts in which information elements appear, or the like. The level of importance is also described in detail in Reference Document 1.

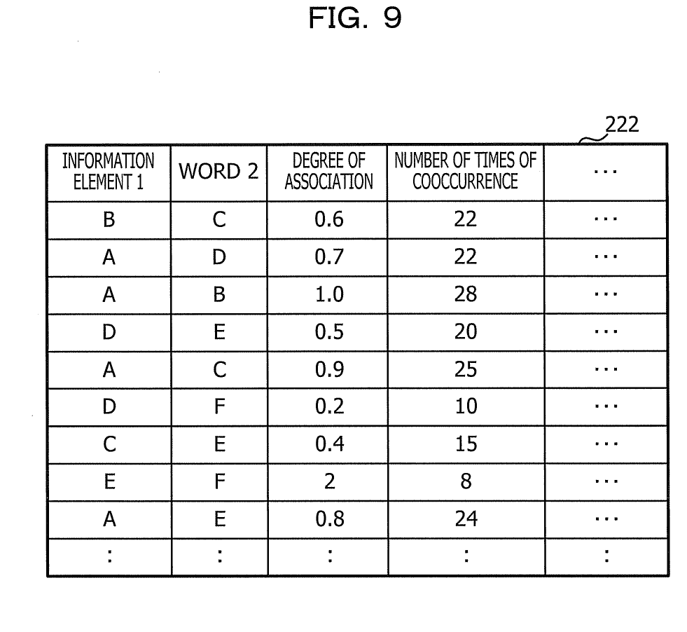

FIG. 9 is a diagram showing an example of association information of information elements. In FIG. 9, association information 222 includes a degree of association and a number of times of co-occurrence for each of combinations of information elements having associations (an information element 1 and an information element 2). The degree of association is, for example, the total sum of the products of the levels of importance in one unit text, which is described in detail in Reference Document 1. However, in an embodiment, the total sum is weighted. The number of times of co-occurrence is the number of times an information element appears at the same time (co-occurs) in a unit text. Both the degree of association and the number of times of co-occurrence are indexes or statistics indicating the strength of association.

Subsequently, the output-element selecting unit 14 selects (extracts) information elements to be displayed on an information map on the basis of the statistical information 221 and records the selection result 23 in the recording unit (select object to be displayed at S103 in FIG. 7). For example, information elements up to the 50th highest frequency of appearance are selected as nodes. However, information elements may be selected on the basis of other indexes, such as the number of appeared unit texts or the level of importance, included in the statistical information 221.

Next, the extended thinning-out unit 15 executes an association thinning out process (S104). The details of the association thinning out process is described in detail below. Subsequently, the visualization processing unit 16 visualizes an information map on the basis of the information generated by the extended thinning-out unit 15 (S105). For example, the visualization processing unit 16 displays the information map on the display unit 106. Alternatively, the information map may be printed by a printer (not shown). On the information map, the placement positions of the individual nodes are determined depending on the degrees of associations of relation lines connecting the nodes. In other words, the individual relation lines are regarded as springs, and the lengths and strengths of the springs are determined in accordance with the degrees of associations of the relation lines. By causing repulsive force to be exerted on the individual nodes, the placement positions of the nodes are determined at positions where the relationship between the tensions and the initial lengths of the relation lines that has become springs and the repulsive force between the nodes becomes stable. A method for determining the placement positions of the nodes is described in details in “Visualization of Keyword Association for Text Mining”, article by Watanabe, Isamu, and Kazuo Miki, Information Processing Society of Japan, the 55th Fundamental Informatics, 1999.

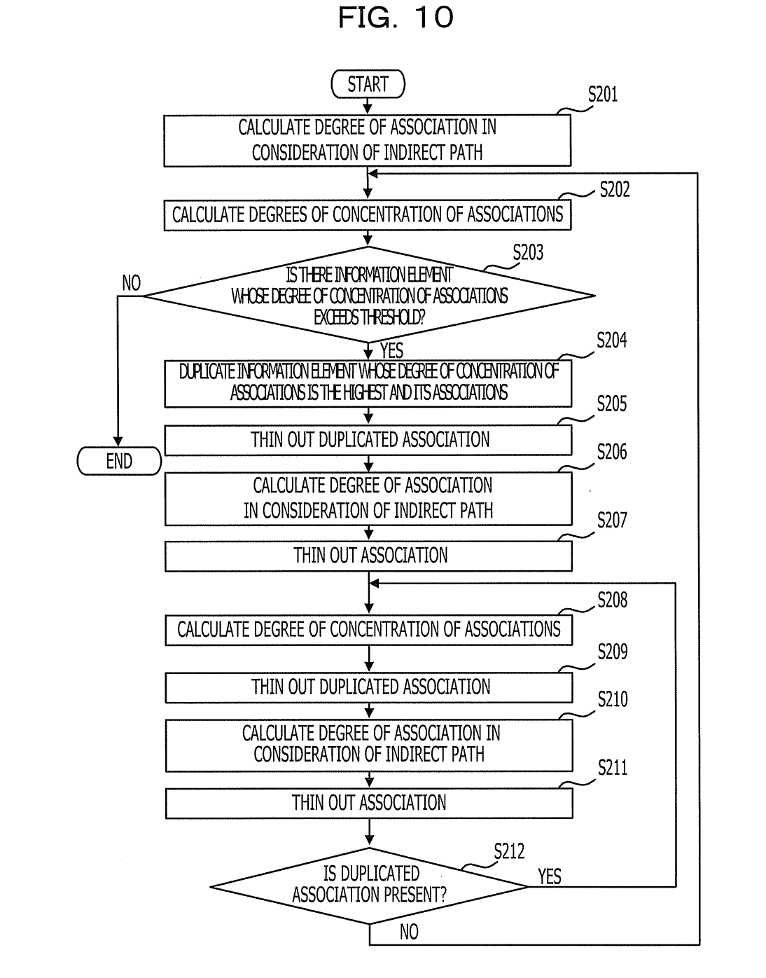

Subsequently, the details of operation S104 is described in detail below. FIG. 10 is a flowchart for describing a procedure of the association thinning out process.

In operation S201, the degree-of-association calculating unit 151, for example, adds the degrees of associations of indirect paths to the degrees of associations (degrees of direct associations) of the individual information elements and records the result of calculation in the recording unit.

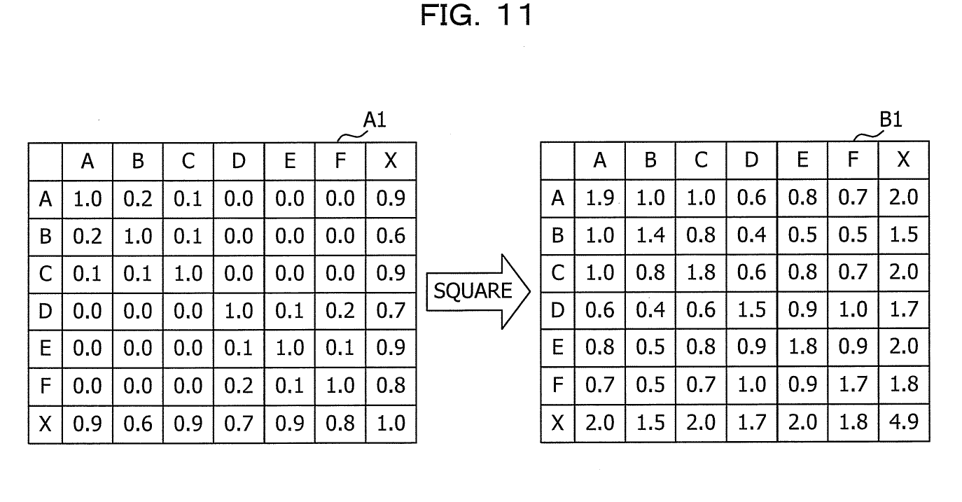

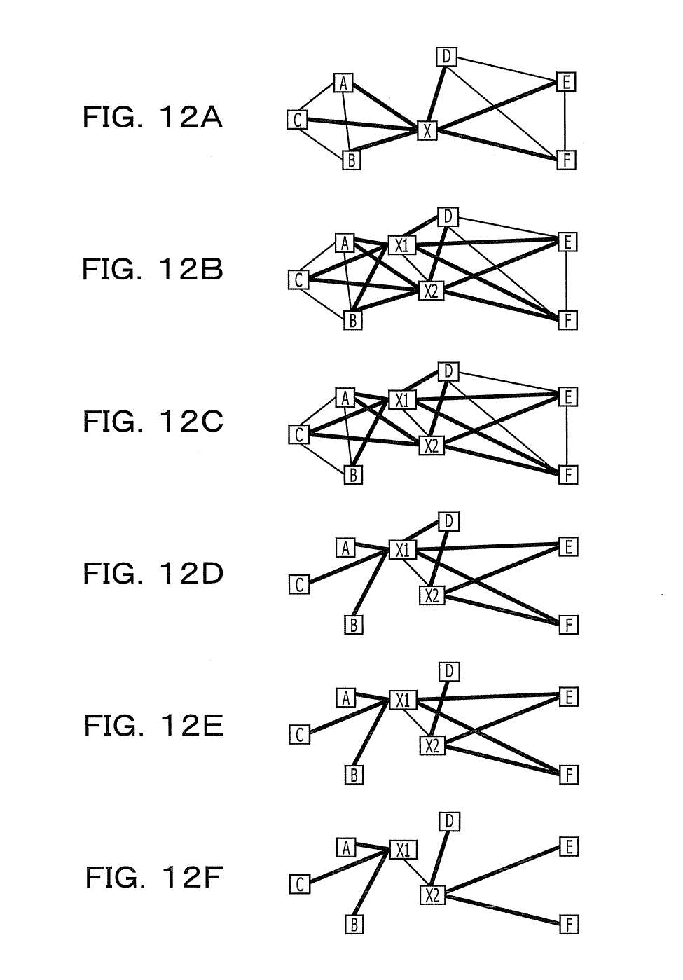

FIG. 11 is a diagram showing a process of adding degrees of associations of indirect paths. In FIG. 11, a table A1 shows a matrix indicating the degrees of associations of direct paths among information elements. The contents of the table A1 can be obtained (derived) from the association information 222. The contents of the table A1 are expressed as an information map shown in FIG. 12A. FIGS. 12A, 12B, 12C, 12D, 12E and 12F are diagrams for visually describing the details of the association thinning out process.

To add the degrees of associations of indirect paths to the individual degrees of associations stored in the table A1, a matrix operation of squaring the matrix shown in the table A1 should be executed. The result of the matrix operation is shown in a table B1. Accordingly, in operation S201, the contents of the table B1 are recorded in the recording unit. The contents of the table A1 are also stored in the recording unit.

Meanwhile, the matrix is squared in consideration of an indirect path (i.e., an indirect path having s distance corresponding to two associations). Accordingly, for an indirect path using three or more associations, the matrix may be raised to the third power or more. In an embodiment, digits are rounded to one decimal place for the sake of convenience. The degrees of associations obtained by adding the degrees of associations of indirect paths (the degrees of associations stored in the table B1) are hereinafter referred to as “indirect-path-added degree of association”.

Subsequently, the degree-of-concentration-of-associations calculating unit 152 calculates the total sum of the degrees of associations (degrees of concentration of associations) for the individual information elements (sums up the degrees of associations) (S202).

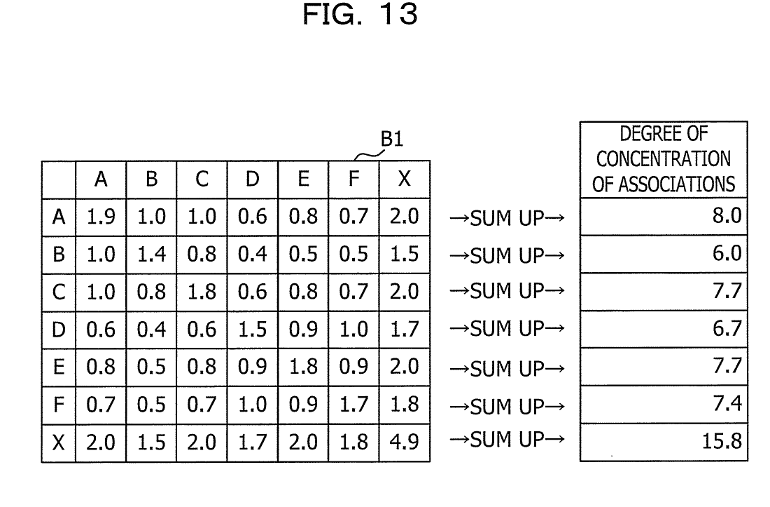

FIG. 13 is a diagram showing a process of calculating the degree of concentration of associations. In FIG. 13, the indirect-path-added degrees of associations are summed up in the row direction of the table B1. As a result, 8.0, 6.0, 7.7, 6.7, 7.7, 7.4, and 15.8 are obtained as the degree of concentration of associations for the information elements A, B, C, D, E, F, and X, respectively. The same result is obtained also by summing the indirect-path-added degrees of associations in the column direction. The degrees of concentration of associations may also be calculated using the degrees of associations of direct associations (degrees of associations stored in the table A1). Instead of the total sum of the degrees of associations, the number of elements whose degree of association is not zero (the number of relation lines connected to the individual information elements), the number of elements exceeding a designated threshold value (the number of relation lines of which the degree of association exceeds a designated threshold value and which are connected to the information elements) or the like may be used as the degrees of concentration of associations.

Subsequently, the duplicating unit 153 determines whether an information element whose degree of concentration of associations exceeds a threshold value (that is, whose associations are concentrated) (S203). The value of threshold should be determined depending on the degree of concentration of associations permitted to a desired information map. For example, assuming that the threshold value is 10, an affirmative determination is made due to the presence of the information element X.

If there is an information element whose degree of concentration of associations exceeds a threshold value (S203: YES), the duplicating unit 153 duplicates an information element whose degree of concentration of associations is the highest among information elements whose degrees of concentration of associations exceed the threshold value and the associations of the information element (S204).

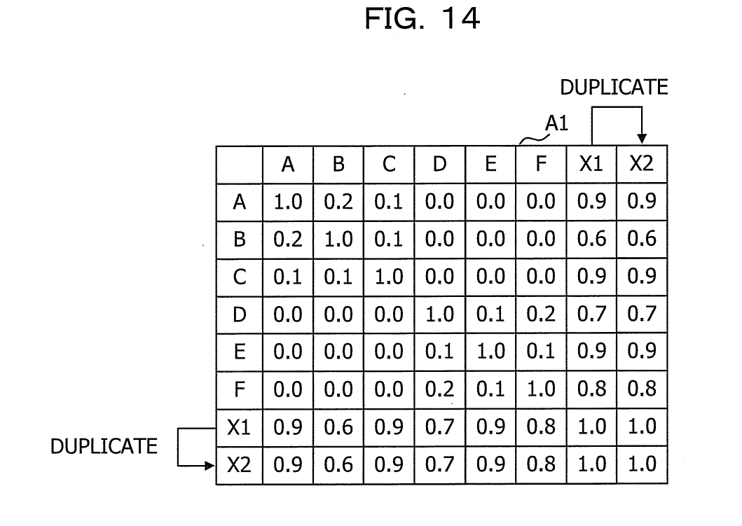

FIG. 14 is a diagram showing a process of duplicating an information element and associations thereof. As shown in FIG. 14, the duplication of the information element and the associations of the information element is achieved by creating duplicates of the row and column of the information element on the table A1. In FIG. 14, the duplication of performed on the information element X. In other words, duplicates of the row and column of the information element X are created. At that time, the degree of association of the duplicate origin and the duplicate target is set at 1.0. However, it may not necessarily be 1.0; for example, it may be set at 0.5, or alternatively, another value.

In FIG. 14, to discriminate between the duplicate origin and the duplicate target, the duplicate origin is referred to as an information element X1, and the duplicate target is referred to as an information element X2. This also applies to the table A1 and the table B1 shown below. The contents of the table A1 in FIG. 14 are expressed as an information map shown in FIG. 12B. In FIG. 12B, the node X and the edges connected to the node X are duplicated.

Subsequently, the duplication eliminating unit 154 selects one of the information elements of the duplicate origin and the duplicate target at random (randomly) and thins out an association whose degree of association is the lowest of the associations of the selected information element (S205). Thus, the duplication of one of associations duplicated due to the duplication is eliminated. The selection of an information element may not be performed at random but by a predetermined method (“selecting a duplicate origin” or the like).

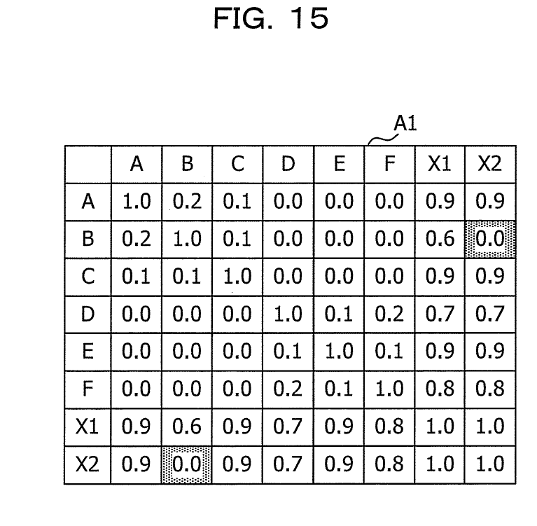

FIG. 15 is a diagram showing a process of thinning out an association duplicated due to duplication. FIG. 15 shows an example in which the information element X2 is selected. Among the associations of the information element X2, the degree of association of an association X2-B having the lowest degree of association is updated to 0.0 (zero). In other words, in an embodiment, the thinning out of association is basically achieved by bringing the degree of the association to zero. The contents of the table A1 in FIG. 15 are expressed as an information map shown in FIG. 12C. In FIG. 12C, an edge X2-B is deleted.

Subsequently, the degree-of-association calculating unit 151 adds the degrees of associations of indirect paths to the degrees of associations of the individual information elements (the degrees of associations of direct associations) on the basis of the table Al in FIG. 15, and records the result of calculation in the recording unit (S206). In other words, the degree-of-association calculating unit 151 squares the matrix shown on the table A1 in FIG. 15.

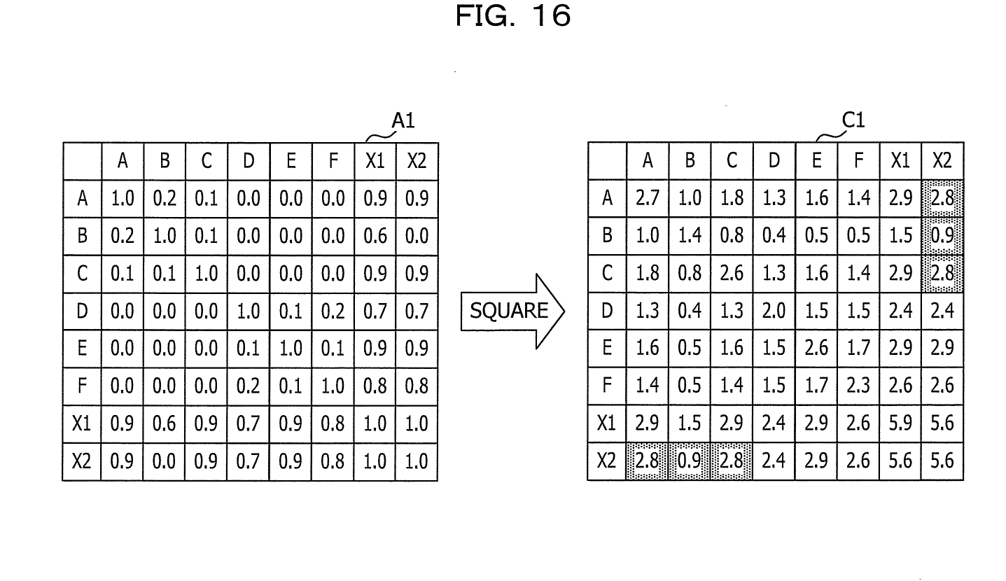

FIG. 16 is a diagram showing the process of adding the degrees of associations of indirect paths. In FIG. 16, the result of squaring the matrix of the table A1 (indirect-path-added degrees of associations) is stored in a table C1. Since the duplication of some association of the information element X1 and the information element X2 is eliminated, the symmetry of the indirect paths of both information elements is broken down. Specifically, for associations with the information elements A, B, and C, the indirect-path-added degrees of associations become different between the information element X1 and the information element X2. In a downstream process, the information elements or the associations of the duplicate origin and the duplicate target are differentiated using such symmetry breakdown.

Subsequently, the thinning-out unit 155 determines an association to be thinned out on the basis of the indirect-path-added degrees of associations of the table C1 and thins out the association (S207). However, with the thinning out by the thinning-out unit 155, the degree of association of the association to be thinned out is not set at zero at this time (the time in operation S207). This is because, if the degree of association of the association thinned out by the thinning-out unit 155 is brought to zero, information on the indirect path is lost, which makes calculation using information on the indirect path difficult thereafter. Accordingly, the thinning-out unit 155 gives the association to be thinned out information indicating that it is thinned out (for example, flag information).

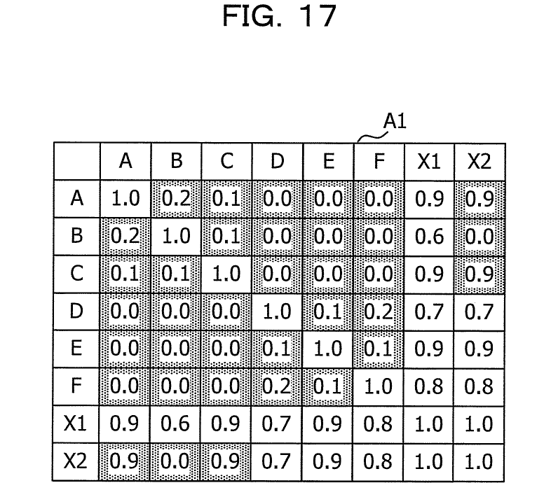

For example, if a method that the thinning-out unit 155 thins out all the associations of the information elements other than one association whose degree of association is the highest is employed, the result of thinning-out is as shown in FIG. 17.

FIG. 17 is a diagram showing a result of thinning-out. On the table A1 in FIG. 17, the half-tone cells are cells concerning the associations thinned out heretobefore (in operations S205 and S207). However, the values (degrees of associations) of the half-tone cells are not set at zero. The contents of the table A1 in FIG. 17 are expressed as an information map shown in FIG. 12D.

For an information element having a plurality of associations whose degree of association is the highest, the plurality of associations are not to be thinned out at this point of time. However, a thinning-out method by the thinning-out unit 155 is not limited to a specific one. The thinning-out may be executed using another known or well-known method. For example, not associations other than one association whose degree of association is the highest but associations up to the Nth lowest association may be thinned out. Alternatively, associations to the Nth lowest association may be thinned out not for each information element but for a set of all the associations. The thinning out method described in Japanese Patent No. 4167855 may be used. Alternatively, for associations duplicated due to duplication, an association with a lower degree of association on the table C1 may be thinned out. If the method of thinning out all the associations other than one whose degree of association is the highest is adopted, one of associations duplicated due to duplication is thinned out at high possibility. In other word, although elimination of the duplication of associations is responsible for the duplication eliminating unit 154, the duplication of associations may be eliminated by the thinning-out unit 155 intentionally or accidentally. Since elimination of the duplication of associations is one of conditions to terminate the process, as described in detail below, the speeding-up of the process can be expected by eliminating the duplication of associations also by the thinning-out unit 155.

Subsequently, the degree-of-concentration-of-associations calculating unit 152 calculates the total sum of the indirect-path-added degrees of associations (degree of concentration of associations) for each information element (S208).

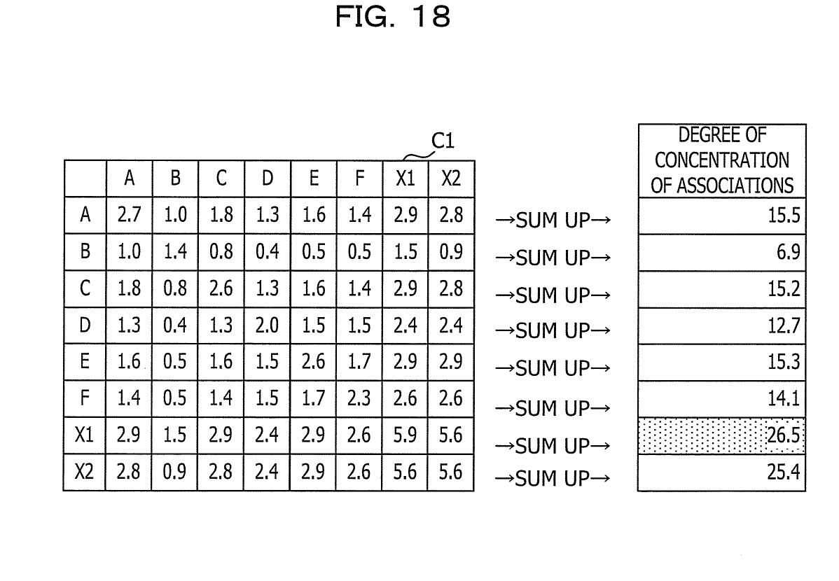

FIG. 18 is a diagram showing a process of calculating the degree of concentration of associations. In FIG. 18, the indirect-path-added degrees of associations are summed up in the row direction of the table C1. The degrees of concentration of associations may be calculated using the degrees of associations of direct associations (the degrees of associations stored in the table A1) as in operation S202. In operation S208, the degree of concentration of associations should be calculated for each of the duplicate origin and the duplicate target of at least the duplicated information element.

Subsequently, if, among the duplicated associations, there are associations of both the duplicate origin and the duplicate target not excluded from the object to be displayed, the duplication eliminating unit 154 thins out an association whose degree of association is the lowest of the associations of information elements having high degree of concentration of associations from the information elements of the duplicate origin and the duplicate target (S209).

In FIG. 18, the degree of concentration of associations of the information element X1 is higher. Accordingly, the duplication eliminating unit 154 updates the value of an association X1-D whose degree of association is the lowest of the associations of the information element X1 to zero on the table A.

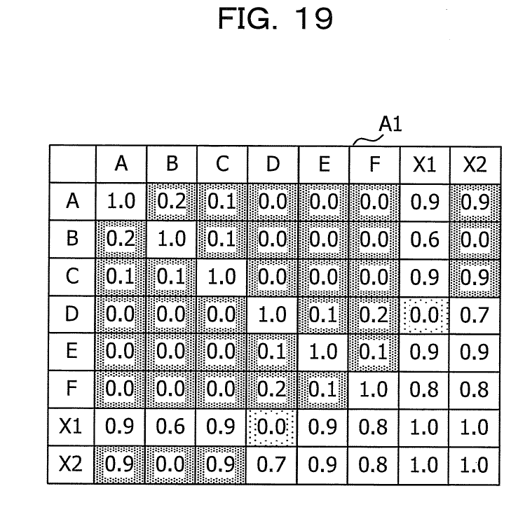

FIG. 19 is a diagram showing a process of thinning out an association duplicated due to duplication. On the table A1 in FIG. 19, the value of the association X1-D is updated to zero. The half-tone cells are cells concerning the associations thinned out heretobefore (in operations S205, S207, and S209). The contents of the table Al in FIG. 19 are expressed as an information map shown in FIG. 12E. In FIG. 12E, an edge X1-D is deleted.

Subsequently, the degree-of-association calculating unit 151 adds the degrees of associations of indirect paths to the degrees of associations of the individual information elements (the degrees of associations of direct associations) on the basis of the table Al in FIG. 19 and records the result of calculation on the recording unit (S210). In other words, the degree-of-association calculating unit 151 squares the matrix shown on the table A1 in FIG. 19.

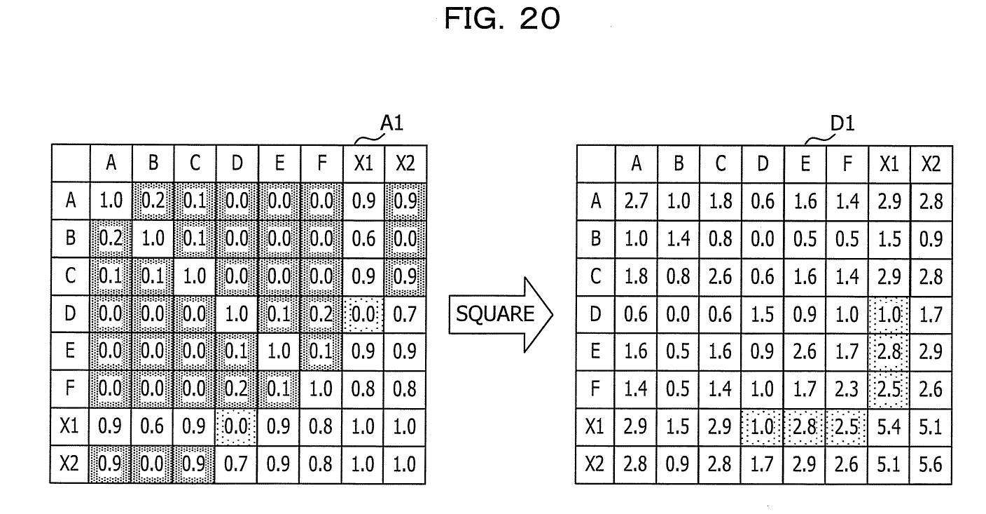

FIG. 20 is a third diagram showing the process of adding the degrees of associations of indirect paths. In FIG. 20, the result of squaring the matrix of the table A1 (indirect-path-added degrees of associations) is stored in a table D1. Since the duplication of the associations of the information element X1 and the information element X2 is further eliminated, the symmetry of the indirect paths of both the information elements is further broken down. In addition, in the calculation of the indirect-path-added degrees of associations, the value stored in the table A1 is used for the degree of association of the association thinned out by the thinning-out unit 155. That is, it is not handled as zero even if it is thinned out.

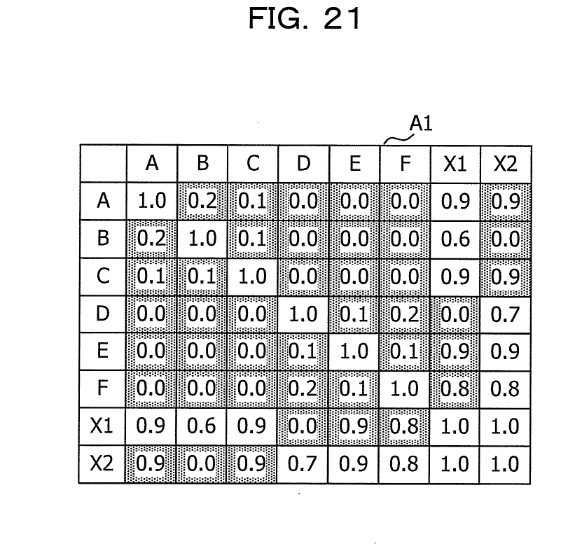

Subsequently, the thinning-out unit 155 determines an association to be thinned out by the same process as in operation S207 and thins out the association (S211). As a result, the table Al becomes the table shown in FIG. 21.

FIG. 21 is a diagram showing a result of thinning-out. The half-tone cells on the table A1 in FIG. 21 are cells concerning the associations thinned out heretobefore (operations S205, S207, and operation S211). Also in operation S211, the degrees of associations of the associations thinned out by the thinning-out unit 155 are not brought to zero at this time. The contents of the table A1 in FIG. 21 are expressed as an information map shown in FIG. 12F.

Subsequently, the duplication eliminating unit 154 determines whether there is a duplicated association left on the basis of the table A1 (S212). Specifically, if the degree of one of the associations of in one row of the column of the information element X1 and the column of the information element X2 on the table A1 is not zero, the associations of the row are determined to be duplicated.

If there is duplicated associations (S212: YES), the extended thinning-out unit 15 repeats operations S208 to S211 until the duplicated associations are eliminated (until one of the duplicate origins and the duplicate targets of all duplicated associations is excluded from the object to be displayed)

If the duplication of associations is eliminated (S212: NO), the process returns to operation S202, where the degree of concentration of associations is calculated by the degree-of-concentration-of-associations calculating unit 152 on the basis of the table D1. If the highest value of the calculated degree of concentration of associations is smaller than or equal to the threshold value (S203), the process in FIG. 10 is terminated.

If the highest value of the calculated degree of concentration of associations exceeds the threshold value, the process after operation S204 is repeated. Accordingly, an information element whose degree of concentration of associations is the highest is duplicated, and the associations of the information element are distributed to a duplicate origin and a duplicate target. The duplication is repeatedly executed until an information element whose degree of concentration of associations is larger than the threshold value is eliminated, so that concentration of associations is appropriately eliminated. However, the numbers of rows and columns of the table A1 increase in accordance with the duplication of the information elements. Accordingly, in the case where the degree of concentration of associations is calculated on the basis of the indirect-path-added degree of association, there is a possibility that the degree of concentration of associations becomes higher than that before the duplication. Accordingly, in this case, the threshold value in operation S203 may be changed with the number of times of duplication.

Thereafter, in operation S105 described in FIG. 7, an information map is displayed on the basis of the table Al in the state in which the process in FIG. 10 ends. At that time, the visualization processing unit 16 excludes, from the object to be displayed, the associations of which the degrees of associations are zero or to which information indicating that they are thinned out is added. Accordingly, edges indicating the associations are not displayed. As a result, in an embodiment, an information map as shown in FIG. 12F is displayed. Alternatively, the degrees of association of associations to which information indicating that they are thinned out is added (that is, associations thinned out by the thinning-out unit 155) may be brought to zero after the end of the process in FIG. 10 and before the process of the visualization processing unit 16. In this case, the visualization processing unit 16 should simply exclude associations whose degrees of associations are zero from the object to be displayed.

As described above, according to an embodiment, an information element (node) to which associations (edges) concentrate is duplicated (divided), and the associations of the information element are distributed to a duplicate origin and a duplicate target. This allows concentration of edges to a specific node to be avoided while leaving an edge corresponding to a strong association.

Furthermore, when an information element is duplicated, associations connected to the information element are also duplicated. At that time, the associations of the duplicated information element X1 and the associations of the information element X2 have completely the same degrees of associations (strengths) (for example, an association X1-A and an association X2-A have the same degree of association). This makes it impossible to determine which of the associations should be given a higher priority for deletion. Thus, an embodiment introduces a degree of association reflecting an indirect path so that a group of information elements having mutually strong associations gathers around the duplicated information element.

Specifically, the degrees of associations (indirect-path-added degrees of associations) of individual information elements that take indirect paths into account are calculated, and the thinning out process by the thinning-out unit 155 is performed on the basis of the indirect-path-added degrees of associations. This allows information elements having mutually strong associations to be gathered around the duplicate origin or the duplicate target. In other words, a node group connected to one node can be divided to node groups having mutually strong associations. For example, for the information elements A, B, C, D, E, and F in FIG. 12, the information elements A, B, and C are grouped to a first group; the information elements D, E, and F are grouped into a second group; the first group can be placed around the information element X1, and the second group can be placed around the information element X2.

In the elimination of the duplication of associations by the duplication eliminating unit 154, the associations of information elements whose degrees of concentration of associations are higher are thinned out. This allows, for example, the same associations of the duplicate origin and the duplicate target to be thinned out in balance (allows the associations to be distributed to the information element of the duplicate origin and the information element of the duplicate target in balance).

Here, the number of associations that the duplication eliminating unit 154 thins out may be two ore more; however, eliminating duplication one by one in the loop of operations S208 to S211, as in an embodiment, can improve the balance of distribution of associations.

Thus, according to an embodiment, a highly legible information map can be created without losing important information, which CaO contribute to improving the accuracy of document search and analysis and saving time and labor and overall efficiency.

According to an embodiment a computer readable medium having a program stored therein causes a computer to execute an operation of information mapping including duplicating a node related to elements has a degree of relationship beyond a predetermined threshold, and creating an information mapping by eliminating associations of one or more elements of a duplicate origin and a duplicate target.

In an embodiment, although the process in FIG. 10 uses the degree of association as an index indicating a strength of association, the process in FIG. 10 may be executed using an index other than the degree of association. For example, a number of times of co-occurrence may be used. Alternatively, a known index indicating the strength of association may be used instead of the degree of association.

While embodiments of the present invention have been described in detail, the invention is not limited to such a specific embodiment, and various modifications and changes can be made without departing from the spirit of the invention described in the claims.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc—Read Only Memory), and a CD-R (Recordable)/RW.

Further, according to an aspect of the embodiments, any combinations of the described features, functions and/or operations can be provided.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although a few embodiment(s) of the present invention(s) has(have) been described in detail, it should be understood that the various changes, substitutions, and alterations could be made hereto without departing from the spirit and scope of the invention, the scope of which is defined in the claims and their equivalents.

What is claimed is:

1. An information-map creating apparatus that creates an information map representing associations among information elements, the apparatus comprising:
duplicating unit for summing first strengths of associations of individual information elements and creating a duplicate of an information element selected based on a sum of the first strengths, along with associations of the selected information element;
degree-of-association calculating unit for calculating second strengths, including direct paths, of the associations among the information elements in a state in which some association whose strength is relatively low is excluded from the associations of one of the information elements of a duplicate origin and the information element of a duplicate target;
degree-of-association summing unit for summing the second strengths of the associations of each of the information elements of the duplicate origin and the duplicate target; and
duplication eliminating unit for excluding, from an object to be displayed, an association whose second strength is relatively low among the associations of one information element, whose strength summed by the summing unit is higher than others, of the information elements of the duplicate origin and the duplicate target.

2. The information-map creating apparatus according to claim 1, comprising:
thinning-out unit for excluding, from the object to be displayed, not only duplicated associations but also an association whose second strength is relatively low.

3. The information-map creating apparatus according to claim 1, wherein the summing of the second strengths by the summing unit and the exclusion of an association from the object to be displayed by the duplication eliminating unit are repeated until all duplicated associations of one of the duplicate origin and the duplicate target are excluded from the object to be displayed.

4. The information-map creating apparatus according to claim 3, wherein after all the duplicated associations of one of the duplicate origin and the duplicate target have been excluded from the object to be displayed, the duplicating unit creates a duplicate of an information element selected based on a sum calculated by the summing unit in accordance with a comparison between the sum and a threshold value, along with the associations of the information element.

5. A method implemented via a computer to create an information map representing associations among information elements, the computer executes an operation comprising:
summing first strengths of associations of individual information elements and creating a duplicate of an information element selected based on a sum of the first strengths, along with the associations of the selected information element;
calculating second strengths, including direct paths, of the associations among the information elements in a state in which some association whose strength is relatively low is excluded from the associations of one of the information elements of a duplicate origin and the information element of a duplicate target;
summing the second strengths of the associations of each of the information elements of the duplicate origin and the duplicate target; and
excluding, from the object to be displayed, an association whose second strength is relatively low among the associations of one information element, whose strength summed by the summing unit is higher than others, of the information elements of the duplicate origin and the duplicate target.

6. The method of creating an information map according to claim 5, comprising:
excluding, from an object to be displayed, not only the duplicated associations but also an association whose second strength is relatively low.

7. The method of creating an information map according to claim 5, wherein the summing and the eliminating duplication are repeated until all duplicated associations of one of the duplicate origin and the duplicate target are excluded from the object to be displayed.

8. The method of creating an information map according to claim 7, wherein after all the duplicated associations of one of the duplicate origin and the duplicate target have been excluded from the object to be displayed, the duplicating unit creates a duplicate of an information element selected based on a sum calculated by the summing unit in accordance with a comparison between the sum and a threshold value, along with the associations of the information element.

9. A method of information mapping, comprising:
duplicating a node related to elements having a degree of relationship beyond a predetermined threshold; and
creating an information mapping by eliminating associations of one or more elements of a duplicate origin and a duplicate target.

10. The method of information mapping according to claim 9, the predetermined threshold depends on a degree of concentration of associations permitted to a desired information map.
